(19) United States
(12) Patent Application Publication
(10) Pub. No.: US 2016/0242035 A1
(43) Pub. Date: Aug. 18, 2016

(54) AUGMENTED REALITY FOR WEARABLES WITH USER-SPECIFIC SECURE CONTENT SYSTEMS AND METHODS

(71) Applicant: AKT IP Ventures LLC, Washington, DC (US)

(72) Inventor: Nicolas Chaillan, Washington, DC (US)

(21) Appl. No.: 14/624,457

(22) Filed: Feb. 17, 2015

(51) Int. Cl. H04W 12/08; H04L 29/06; H04W 4/04; H04L 29/08; H04B 1/3827; H04W 12/06

(52) U.S. Cl. CPC H04W 12/08; H04B 1/385; H04W 12/06; H04W 4/04; H04L 67/18; H04L 63/08; H04L 63/105; H04L 67/306

(57) ABSTRACT

Examples of systems and methods for presenting and accessing confidential secure information to pre-authenticated users of a content management system on wearables using augmented reality are provided. The system includes wearable devices, client computing devices, a content management system (CMS), and a communication network. In some embodiments, the system also includes an internet cloud and a global database. The method includes the steps of authenticating wearable devices; detecting displays; recognizing content displayed on the displays; pushing associated secure data to wearable devices; calculating display angles based on head motion and movements feedback; processing secure data received at wearable devices to form adapted AR layers; rendering the adapted AR layers onto the screens of the wearable devices, monitoring head movement for maintaining adapted AR layer synchronization, and modifying the adapted AR layers based on the monitored head movement.

### BACKGROUND

1. Field of the Disclosure

The present disclosure relates generally to augmented reality for wearable devices, and more particularly, to a method and system for augmented reality for wearable devices with user-specific secure content and access control.

2. Background Information

Augmented reality technology (AR) is a live, direct, or indirect view of a physical, real-world environment whose elements are augmented (or supplemented) by computer-generated sensory input so as to achieve a sensory experience that transcends reality. For example, when taking a video or picture of a building using a camera, a user overlays an introduction of the building, or a name and contact information of the company owning the building, and the like, on the video or picture.

In one particular example, conference rooms are usually used by organizations to present information to users for various purposes such as to sell goods/services, answer questions, and/or provide information about any subject. Further to this example, consider a public presentation conducted in a conference room by a financial services firm. Public presentations typically use generic, non-private information that is displayed to all of the users attending the presentation. In these presentations, attendees view slides or other information presented during the presentation that are populated with generic non-private information so that the information can be displayed to all users attending the presentation. In this example, in order for a user to view the user's private information, the user engages in an off-line or side conversation (e.g., a one-on-one consultation with a financial services firm's representative) to review the user's private information. Therefore, what is desirable is a more efficient way of presenting confidential information to selected users within a general audience.

### SUMMARY

A system and method for presenting confidential and user-specific information to authenticated users of a content management system using augmented reality is disclosed. In one or more embodiments, the content management system operates within a system architecture that includes components that dynamically interact with each other through network connections. In these embodiments, the system includes one or more components, such as, for example, client computing devices, wireless enabled devices, wearable devices, wireless enabled wearable devices, a communication network, a content management system (CMS), an internal database, an Internet cloud, and a global database. The content management system further includes a data processing module, an image processing module, and an augmented reality (AR) content module. It should be understood that system can include more components, less components, or different components depending on desired goals.

In an exemplary embodiment, a system, method, and computer readable medium are disclosed for providing user-specific content to a client device (e.g., a wearable device) from a content management system. The content management system can receive a request to authenticate the client device, authenticate the client device based on the request, and determining that a user of the client device has access to user-specific content based on the authenticating. Additionally, the content management system can receive position information associated with the client device and provide the user-specific content to the client device, where the user-specific content corresponds to the position information and the user.

In an additional exemplary embodiment, a system, method, and computer readable medium are disclosed for presenting user-specific content, received from a content management system, to a user of a client device (e.g., a wearable device). The client device can transmit a request to authenticate the client device to the content management system, and the request can include user-identification data from the user. Additionally, the client device can determine position information for the client device. The client device can receive, from the content management system, user-specific content, where the content management system determined that the user has access to the user-specific content based on authenticating the client device using the user-identification data. Further, the client device can render and display, on a display of the client device, an adapted AR layer based on the position information, where the adapted AR layer includes the user-specific content.

In exemplary operation, a group of people gather in a conference room to have a meeting about a certain matter. The conference room includes client computing devices such as displays connected to a PC or Smart TVs hanging on the wall where information globally available to all members of the group may be displayed. The people in the conference room can have different security clearances and different roles where only a few of them are allowed to view and access specific secure information. Attendees in the conference room can be required to use wearable devices such as, for example, glasses that include cameras and sensors so as to be able to see confidential information in addition to the information publicly displayed on the displays connected to a PC or on the Smart TVs. In this embodiment, the users of wearable devices log into a content management system and are securely authenticated. The wearable devices capture relevant data, such as, size, shape, and viewing angle as well as current content being displayed on each of the displays (e.g., Smart TVs) that enters the field of view of the wearable device. The relevant data collected is sent along with user data and head motion feedback to the content management system through wirelessly enabled devices via the communication network. The content management system then uses the received data to produce an adapted AR layer (according to the user's rights and settings) for each wearable device according to their viewing angle and position. The content management system then pushes the associated adapted AR layer back to each wearable device and each wearable device renders the adapted AR layer on the screen of the wearable device so as to appear aligned and as part of the images displayed by the displays. The users of wearable devices also receive additional information according to the user identity, such as, live notifications related to the meeting. The content management system, based on wearable devices information, can constantly determine head movement of the users so as to keep the adapted AR layer synchronized with the client computing devices. The content management system executes different algorithms that can, for example, identify a screen and calibrate the adapted AR layer orientation to the identified screen so the user associated with each wearable device views the image as substantially upright.

According to some embodiments, a method for presenting confidential information to authenticated users of a content management system using augmented reality includes a plurality of steps performed by a processor. The steps include: authenticating wearable devices by the CMS; detecting displays; recognizing content displayed on displays; pushing associated secure data to wearable devices; calculating display angles based on head motion feedback; adapting the AR layer pushed to wearable devices; and monitoring head movement for maintaining adapted AR layer synchronization.

According to some embodiments, a method for calculating the rotational and translational movement of the wearable devices with respect to the screens of the client computing devices includes a plurality of steps performed by a processor. The steps include: triggering a timer and detection of steadiness; waiting for a predetermined period of time; detecting movement of the user operating the wearable devices; identifying the type of movement; if the movement identified is a rotational movement, then determining the type(s) of rotational movement; if the movement identified is a translational movement, then determining the type(s) of translational movement; when the movement is rotational, determining if the rotational movement is tilting forward and backward (pitching); if the movement is pitching then applying a pitching algorithm; if the movement is not pitching, then determining if the movement is turning left and right (yawing); if the movement is yawing then applying a yawing algorithm; if the movement is not yawing, then determining if the movement is tilting side to side (rolling); if the movement is rolling then applying a rolling algorithm; if the movement is not rolling, then determining if there is translational movement; if there is no translational movement, then the method returns to the main algorithm; When the movement is translational, then determining if the translational movement is moving up or down (heaving); if the movement is heaving then applying a heaving algorithm; if the movement is not heaving, then determining if the movement is left or right (swaying); if the movement is swaying, then applying a swaying algorithm; if the movement is not swaying, then determining if the movement is forward or backward (surging); if the movement is surging, then applying a surging algorithm; if the movement is not surging, then the method returns to the main algorithm.

According to some embodiments, a method for monitoring the head movement of the users of wearable devices to maintain the adapted AR layer synchronization includes a plurality of steps performed by a processor. The steps include: triggering a timer and detection of steadiness; waiting for a predetermined period of time; detecting head movement of the user of the wearable devices; waiting for another predetermined period of time if head movement is not detected; detecting a screen if head movement is detected; recognizing displays and their content; determining if the user of the wearable device is looking at the same display; disabling an adapted AR layer if the user is not looking at the same display; adding an adapted AR layer on top of the image being displayed if the user of the wearable device is looking at the same screen; repeating the waiting step again and continue with a loop until the user looks away from the screen.

According to some embodiments, a method for processing encrypted metadata received from an outside source to be fed in the content management system includes a plurality of steps performed by a processor. The steps include: receiving the encrypted data from a global database; decrypting the data and reading metadata; assigning a special category of data to each user based on a user profile, credentials and settings; and pushing associated filtered secure data to wearable devices according to each user's rights and settings.

In one or more embodiments, the methods and system described above may be deployed in conference rooms, movie theaters, museums, retail stores, living rooms, training rooms, and the like.

Numerous other aspects, features and benefits of the present disclosure may be made apparent from the following detailed description taken together with the drawing figures.

### BRIEF DESCRIPTION OF THE FIGURES

Non-limiting embodiments of the present invention are described by way of example with reference to the accompanying figures which are schematic and are not intended to be drawn to scale. Unless indicated as representing the background art, the figures represent aspects of the invention.

FIG. 1 is a block diagram illustrating a system that allows authenticated users of wearable devices to see confidential information on one or more client computing devices, according to an embodiment;

FIG. 2 is a block diagram illustrating an exemplary computing device in which one or more embodiments of the present disclosure may operate, according to an embodiment;

FIG. 3 is a block diagram illustrating a content management portion of the system of FIG. 1, according to an embodiment;

FIG. 4 is an exemplary illustration of a system deployment, in a conference room, for allowing authenticated users of wearable devices to see confidential information on one or more client computing devices, according to an embodiment;

FIG. 5 is an exemplary illustration of a system deployment, in a conference room, for adjusting the adapted AR layer to compensate for lateral head movement (“head tilt”) and allowing authenticated users of wearable devices to view confidential information on one or more client computing devices, according to an embodiment;

FIG. 6 is a flowchart of a method for presenting confidential information to authenticated users of a content management system using augmented reality, according to an embodiment;

FIG. 7 is a flowchart of a method for calculating the rotational and translational movement of the wearable devices with respect to the screens of the client computing devices, according to an embodiment;

FIG. 8 is flowchart of a method for calculating the head pitch movement (forward and backward) angle based on the motion feedback of the wearable devices, according to an embodiment;

FIG. 9 is a flowchart of a method for calculating the head yaw movement (left and right) angle based on the motion feedback of the wearable devices, according to an embodiment;

FIG. 10 is a flowchart of a method for calculating the head roll movement (side-to side) angle based on the motion feedback of the wearable devices, according to an embodiment;

FIG. 11 is a flowchart of a method for calculating the translational movement of the wearable devices regarding the up and down movement (heaving), according to an embodiment;

FIG. 12 is a flowchart of a method for calculating the translational movement of the wearable devices regarding the left and right movement (swaying), according to an embodiment;

FIG. 13 is a flowchart of a method for calculating the translational movement of the wearable devices regarding the forward and backward movement (surging), according to an embodiment;

FIG. 14 is a flowchart illustrating a method for maintaining adapted AR layer synchronization by monitoring the head movement of the users of wearable devices; and

FIG. 15 is a flowchart of a method for processing encrypted metadata received from an outside source to be fed into the content management system.

### DETAILED DESCRIPTION

### Description of the Drawings

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

System Components and Architecture

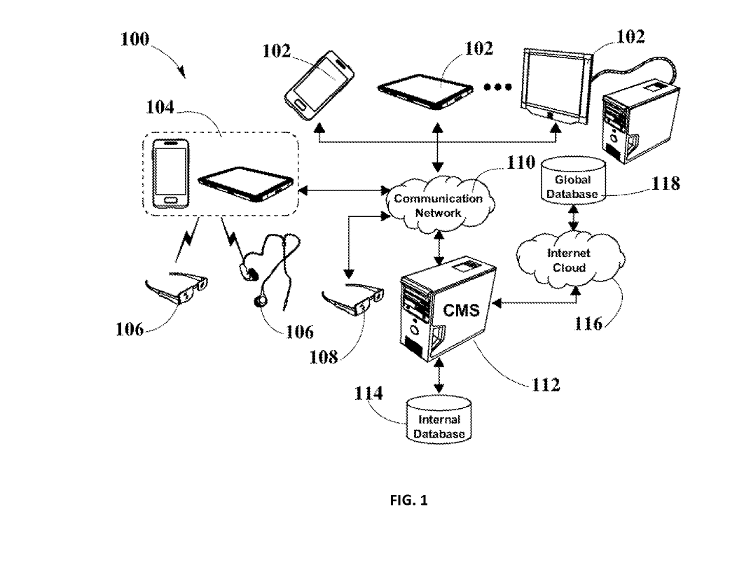

FIG. 1 is a block diagram illustrating a system that allows authenticated users of wearable devices to see confidential information on one or more client computing devices, according to an embodiment. In one or more embodiments, the system can be deployed in a conference room environment where authenticated users of wearable devices may have different rights and settings in the system authorizing them to see different information on the screens within the conference room environment.

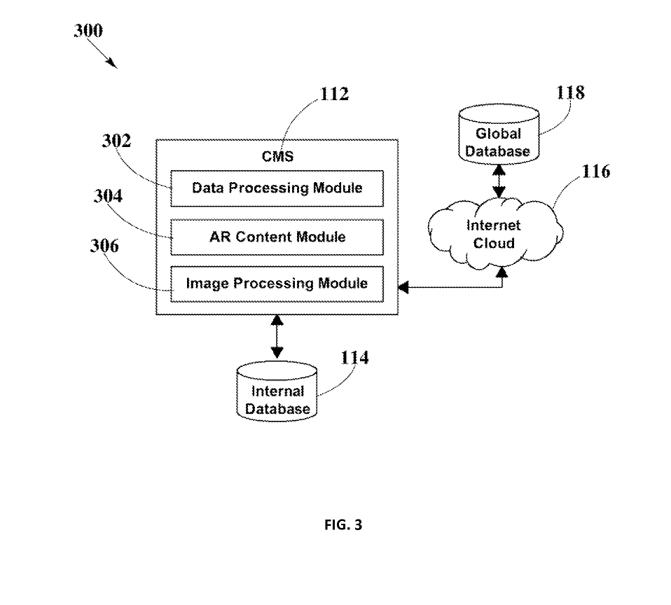

In FIG. 1, system 100 includes client computing devices 102, wireless enabled devices 104, wearable devices 106, wireless enabled wearable devices 108, a communication network 110, a content management system 112 (CMS), an internal database 114, an Internet cloud 116, and a global database 118. Content management system 112 further includes one or more software modules such as, one or more data processing modules, one or more Augmented Reality (AR) content modules, and one or more image processing modules. The software modules contained/operating within content management system 112 are further described in FIG. 3. It should be understood that system 100 can include more components, less components, or different components depending on desired goals.

In FIG. 1, client computing devices 102 are operatively coupled to and in bi-directional wired/wireless communication with one or more wireless enabled devices 104, wireless enabled wearable devices 108, and content management system 112. Wireless enabled devices 104 are further operatively coupled to and in bi-directional wired/wireless communication with one or more wearable devices 106. Content management system 112 is further operatively coupled to and in bi-directional communication with one or more internal databases 114 and one or more global databases 118. Each of the software modules within content management system 112 may be implemented as a set of computer instructions executed by central processing units that run computer executable program instructions or related algorithms.

Each of the different components of system 100 may be implemented using any type of suitable processor-controlled device(s) that receives, processes, and/or transmits digital data configured as further described below. Examples of devices incorporating one or more suitable processor-controlled devices include smartphones, desktop computers, laptop computers, servers, tablets, PDAs, specialized computing platforms for image processing, data processing, augmented reality rendering, and the like.

In FIG. 1, content management system 112 is implemented as software that runs on a server that includes a processing unit for running related algorithms or computer executable program instructions. The processing unit may include a processor with computer-readable medium, such as a random access memory (RAM) (not shown) coupled to the processor. Examples of the processor may include a microprocessor, application specific integrated circuit (ASIC), and field programmable object array (FPOA), among others. In some embodiments, content management system 112 receives data from client computing devices 102, wireless enabled devices 104, and wireless enabled wearable devices 108 through communication network 110. In these embodiments, content management system 112 processes the received data and produces an adapted AR layer which is further pushed to wearable devices 106 so as to allow users of wearable devices 106 to see confidential information associated with user's rights and settings. Further in these embodiments, the adapted AR layer includes confidential information that is overlaid on top of the image/video being viewed by a user operating wearable devices 106. In other embodiments, content management system 112 receives data from global database 118 through Internet cloud 116. In these embodiments, content management system 112 processes the received data and stores the processed data at internal database 114. Examples of data received from client computing devices 102 are location, dimension, shape, and angles of the screens. Examples of data received from wireless enabled devices 104 are location, position, user's credentials, and angles of wearable devices 106 with respect to the client computing devices. Examples of data received from wireless enabled wearable devices 108 are location, position, and the angle the user of wearable device 106 is looking at with respect to client computing devices 102 (head angle), and the like. Examples of data received from a global database include encrypted metadata received from third parties and having already categorized information to be displayed on client computing devices to specific users.

In one or more embodiments, content management system 112 receives data from client computing devices 102, wireless enabled devices 104, and wireless enabled wearable devices 108 through communication network 110. In these embodiments, content management system 112 processes the data received from client computing devices 102, wearable devices 106, wireless enabled wearable devices 108, and wireless enabled devices 104 and calculates the relative position and angles of the wearable devices with respect to the screens of the client computing devices and sends these calculations to wearable devices 106 along with user-specific information. Further to these embodiments, wearable devices 106, including a graphics processing unit that executes an image processing module and an AR content module, processes the received data from content management system 112 and render an AR adapted layer on the displays of wearable devices 106 so as to appear aligned and as part of the images displayed by the client computing devices 102. In one or more embodiments, wearable devices 106, including a central processing unit (CPU) and a graphics processing unit (GPU), receive user-specific information from content management system 112 and calculate the relative position and angles of the wearable devices with respect to the screens of the client computing devices. In these embodiments, wearable devices 102 also render an AR adapted layer on the displays of wearable devices 106 so as to appear aligned and as part of the images displayed by the client computing devices 102.

In one or more embodiments, internal database 114 and global database 118 are implemented as relational databases that provide functions of fetching, indexing, and storing data. Internal database 114 and global database 118 may be implemented through database management systems (DBMS), such as, MySQL, PostgreSQL, SQLite, Microsoft SQL Server, Microsoft Access, Oracle, SAP, dBASE, FoxPro, IBM DB2, LibreOffice Base, FileMaker Pro, and/or any other type of database that may organize collections of data.

In one or more embodiments, wireless enabled devices 104 are implemented as any electronic device able to communicate using one or more suitable wireless technologies. Suitable devices may include client devices in wireless networks, which may send out wireless probe signals in order to detect known Access Points. These may be part of one or more suitable wireless technologies, including Wi-Fi, Bluetooth, VLC, amongst many others. Examples of wireless enabled devices 104 are smartphones, tablets, laptops computers, and the like. In some embodiments, wireless enabled devices 104 receive data from wearable devices 106, processes such data, and sends processed data to content management system 112. Examples of data received from wearable devices 106 are accelerometer readings, position, location, images, objects, and the like. In other embodiments, wireless enabled devices 104 receive data from content management system 112 and send such data to wearable devices 106. Examples of data received from content management system 112 are adapted AR layers that are pushed to wearable devices 106 so as to be placed on top of the images/videos being captured by wearable devices 106.

In one or more embodiments, wearable devices 106 are implemented within or as part of clothing and accessories incorporating computer and advanced electronic technologies. An example of wearable devices 106 are glasses that include a camera, a display, and a plurality of sensors such as, for example, a 3-axis gyroscope, a 3-axis accelerometer, ambient light sensing, proximity sensor, and the like. In these embodiments, wearable devices 106 capture relevant information using their built-in camera and sensors when directed towards client computing devices 102. This relevant information (e.g., camera data, sensor data, etc.) is then sent to content management system 112 for further analysis. Further to these embodiments, wearable devices 106 display confidential information using their built-in display. The confidential information can be presented in the form of AR layers positioned on top of the image/video displayed on client computing devices 102 (e.g., Smartphones, Tablets, Laptops, displays connected to a PC, and Smart TVs).

In exemplary operation, a group of people gather in a conference room to have a meeting about a certain matter. The conference room includes client computing devices 102, such as Smart TVs or a display connected to a PC, hanging on the wall where information available to all members of the group may be displayed. The people in the conference room have different security clearances where only a few of them can see specific information. Each of the attendees at the conference room are required to use wearable devices 106 such as, for example, glasses that include cameras and sensors so as to be able to see the confidential information in addition to the information displayed on displays. In this embodiment, users of wearable devices 106 log into content management system 112 and are securely authenticated. Wearable devices 106 capture relevant data such as location, size, shape, and angles of client computing devices 102 and send said data along with user data and head motion feedback to content management system 112 through wireless enabled devices 104 via communication network 110. Content management system 112 then uses the received data to produce an adapted AR layer (according to the user's rights and settings) for each wearable device 106. Content management system 112 then pushes the associated adapted AR layer back to wearable devices 106 and renders the adapted AR layer on the screen of wearable devices 106 so as to appear as part of the images displayed by the displays. Users of wearable devices 106 also receive additional information according to the user identity, such as, live notifications related to the meeting. Content management system, 112 based on information from the wearable devices 106, can constantly determine head movement of the users so as to keep the adapted AR layer synchronized with client computing devices 102. Content management system 112 executes different algorithms that identify the screen and calibrate the adapted AR layer orientation to the identified screen so the user of wearable devices 106 can view the image as substantially upright.

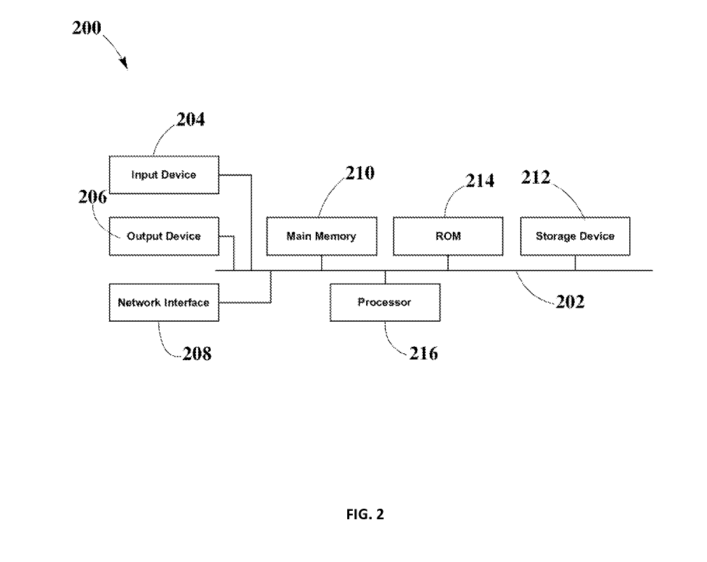

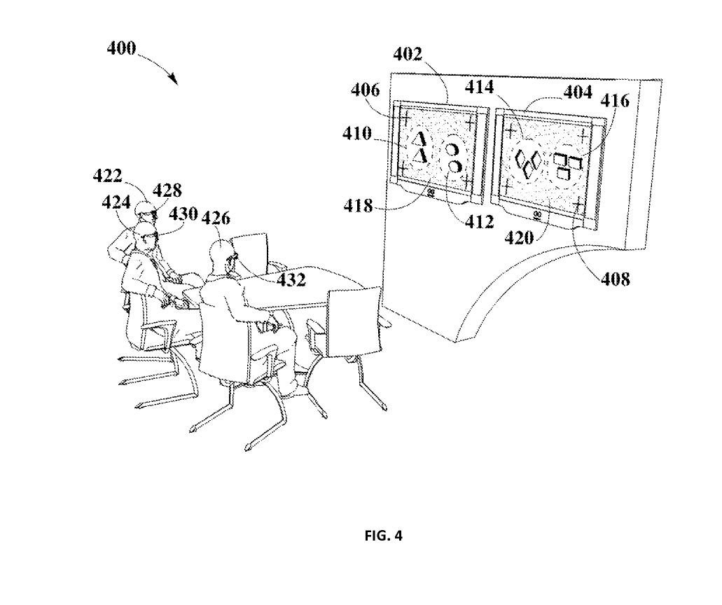

FIG. 2 is a diagram of example components of computing device 200 or server, according to an exemplary embodiment. In FIG. 2, computing device 200 includes example components of computing devices, such as, servers, laptop computers, desktop computers, tablets, smartphones, and the like that may operate within system 100 of FIG. 1, execute modules described in FIG. 3, or execute code implementing concepts/ideas contained in FIGS. 4-8, according to an exemplary embodiment.

According to some aspects of this embodiment, computing device 200 includes bus 202, input device 204, output device 206, network interface 208, main memory 210, storage device 212, read only memory (ROM 214) and processor 216. In another exemplary embodiment, server includes additional, fewer, different, or differently arranged components than are illustrated in FIG. 2.

In one embodiment, bus 202 coordinates the interaction and communication among the components of the server. Input device 204 includes a mechanism that permits a user to input information to computing device 200, such as a keyboard, a mouse, a button, a pen, a touch screen, voice recognition and/or biometric mechanisms, etc. Output device 206 includes a mechanism that outputs information to the operator, such as, a display, a light emitting diode (LED), and a speaker, among others.

Network interface 208 enables computer interactions with other devices and/or systems via a network connection. Network connections may refer to any suitable connection between computers such as intranets, local area networks (LAN), cloud networks, virtual private networks (VPN), wireless area networks (WAN), and the internet, among others.

Main memory 210 includes a random access memory (RAM) or another type of dynamic storage device that may store information and instructions for execution by processor 216. ROM 214 includes a ROM device or another type of static storage device that may store static information and instructions for use by processor 216. Processor 216 includes a microprocessor, an application specific integrated circuit (ASIC), and a field programmable object array (FPOA), among others, that may interpret and execute instructions.

According to some aspects of this embodiment, server, using one or more suitable software modules, enables data fetching, biometrics processing tasks, and predictive analytics. The server performs these operations in response to processor 216 executing software instructions contained in a computer-readable medium, such as main memory 210.

The software instructions reads into main memory 210 from another computer-readable medium, such as storage device 212, or from another device via network interface 208. The software instructions contained in main memory 210 may cause processor 216 to perform processes that will be described later. Alternatively, hardwired circuitry may be used in place of or in combination with software instructions to implement processes described herein. Thus, implementations described herein are not limited to any specific combination of hardware circuitry and software.

FIG. 3 is a block diagram illustrating a portion of the system pertaining to content management system 112, according to an embodiment. In FIG. 3, subsystem 300 includes content management system 112, data processing module 302, AR content module 304, image processing module 306, internal database 114, internet cloud 116, and global database 118. It should be understood that subsystem 300 can include more components, less components, or different components depending on the desired analysis goals. In an example, content management system 112, internal database 114, internet cloud 116, and global database 118, are implemented as described in system 100 of FIG. 1, above.

Content management system 112 is operatively coupled to and in bi-directional communication with data processing module 302, AR content module 304, and image processing module 306. Content management system 112 is further operatively coupled to and in bi-directional communication with internal database 114 and global database 118.

In one or more embodiments, data processing module 302 within content management system 112 is implemented as one or more computer software modules that include programmatic rules or execute/run different algorithms that enabled functions such as, for example, detection, recognition, and identification of client computing devices 102 (Smart TVs and PC enabled displays). In these embodiments, data processing module 302 is configured to process the data received from client computing devices 102, wearable devices 106, wireless enabled wearable devices 108, and wireless enabled devices 104. Further in these embodiments, data processing module 302 calculates the relative position and angles of the wearable devices with respect to the screens of the client computing devices, and sends these calculations to AR Content Module.

In one or more embodiments, AR content module 304 is implemented as one or more computer software modules that include programmatic rules for executing/running different algorithms that use the data received from data processing module and image processing module to render an adapted AR layer (e.g., confidential information, non-suitable information for a viewer, etc.) to be pushed to wearable devices. In these embodiments, AR content module 304 is configured to use AR technology such as, for example, computer vision, object recognition, image registration, and the like.

In one or more embodiments, image processing module 306 is implemented as one or more computer software modules that include programmatic rules for executing/running different algorithms that use data received from client computing devices and global databases. In these embodiments, image processing module 306 executes feature detection methods, such as, corner detection, blob detection, edge detection, thresholding and/or other image processing methods. Further to these embodiments, image processing module 306 processes data received from the global database and stores the received data at the internal database for further use.

FIG. 4 is an exemplary illustration of a system deployment, in a conference room, for allowing authenticated users of wearable devices to view confidential information on one or more client computing devices, according to an embodiment. In FIG. 4, system deployment 400 includes displays 402 and 404, marks 406 and 408, adapted AR layers 410, 412, 414, and 416, background 418 and 420, users 422, 424, and 426, and glasses 428, 430, and 432. It should be understood that system deployment 400 can include more components, less components, or different components depending on the desired goals.

In one embodiment, users 422, 424, and 426 are conducting a meeting in a conference room. In this embodiment, users 422, 424, and 426 are employing wearable devices such as glasses 428. Examples of glasses 428, 430, and 432 include wearable devices having a camera, a display, and a plurality of sensors such as, for example, 3-axis gyroscope, 3-axis accelerometer, ambient light sensing, proximity sensor, and the like. Examples of AR glasses include Google Glass, Microsoft Hololens, CastAR, Moverio BT-200, Meta, Vuzix M-100, Laster SeeThru, Icis, ORA-S, GlassUP, Atheer One, K-Glass, and the like. Further to this embodiment, the conference room is equipped with two displays connected to one or more PC devices or two smart TVs, such as, displays 402 and 404, where both displays are displaying non-confidential information related to the meeting and accessible by all users (background 418 and background 420). In some embodiments, user 422 using glasses 428 is logged into the content management system running on the server (not shown in FIG. 4) as the administrator, user 424 using glasses 430 is logged into the content management system as an operator, and user 426 using glasses 432 is logged into the content management system as a guest. In these embodiments, user 422, as the administrator, can see adapted AR layer 410, 412, 414, and 416, user 424, as an operator, can only see adapted AR layer 412, and 414, and user 426, as a guest, can only see adapted AR layer 416.

In an example, adapted AR layer 410, adapted AR layer 412, adapted AR layer 414, and adapted AR layer 416 are implemented as AR layers associated with different areas of the backgrounds (e.g., backgrounds 418 and 420) and fill those background areas with different levels of confidential information related to banks, such as, financial statement images and the like. In another example, adapted AR layer 410, adapted AR layer 412, adapted AR layer 414, and adapted AR layer 416 are implemented as AR layers including custom information related to product placement. In this example, adapted AR layer 410, adapted AR layer 412, adapted AR layer 414, and adapted AR layer 416 will fill certain areas of the background with product images according to the user's preferences. In yet another example, adapted AR layer 410, adapted AR layer 412, adapted AR layer 414, and adapted AR layer 416 are implemented as AR layers that fill certain areas of the background with live feed (e.g., video). In this example, the users see a live video in a portion of the associated background that is received from either internal or external sources, and depending on the user's rights and settings the user will see what it is authorized to see. In a further example, adapted AR layer 410, adapted AR layer 412, adapted AR layer 414, and adapted AR layer 416 are implemented as pre-processed AR layers that fill certain areas of the background with content governed by parental control (e.g., removing/blurring images associated with specific movie content).

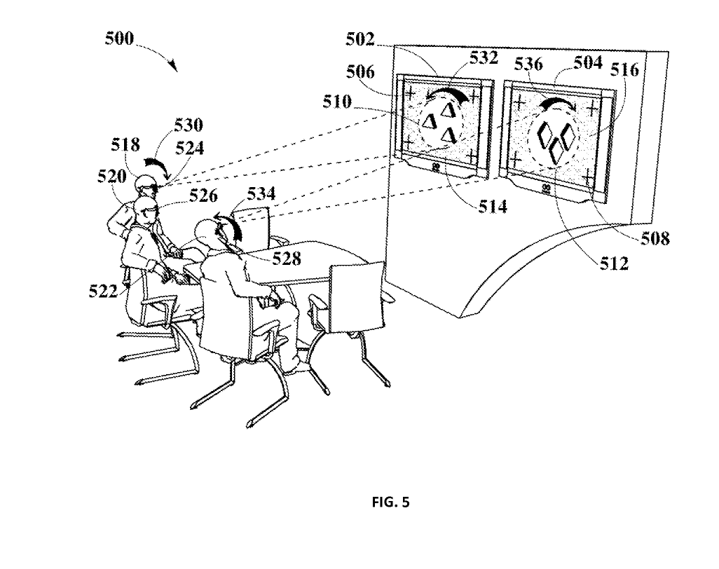

FIG. 5 is an exemplary illustration of a system deployment, in a conference room, for adjusting the adapted AR layer to compensate for lateral head movement (“head tilt”) and allowing authenticated users of wearable devices to view confidential information on one or more client computing devices, according to an embodiment. In FIG. 5, system deployment 500 includes display 502, display 504, mark 506 and 508, adapted AR layer 510 and 512, background 514 and 516, user 518, 520, and 522, and glasses 524, 526, and 528. It should be understood that system deployment 500 can include more components, less components, or different components depending on the desired goals.

In one embodiment, user 518, while looking at display 502, tilts his head to the right 530 and the content management system (not shown in FIG. 5) rotates 532 adapted AR layer 510 counter-clockwise so the user can view the adapted AR layer aligned to background 514 and in a substantially upright position. In another embodiment, user 524, while looking at display 504, tilts his head to the left 534 and the content management system rotates 536 adapted AR layer 512 clockwise so the user can view the adapted AR layer aligned to background 516 and in a substantially upright position.

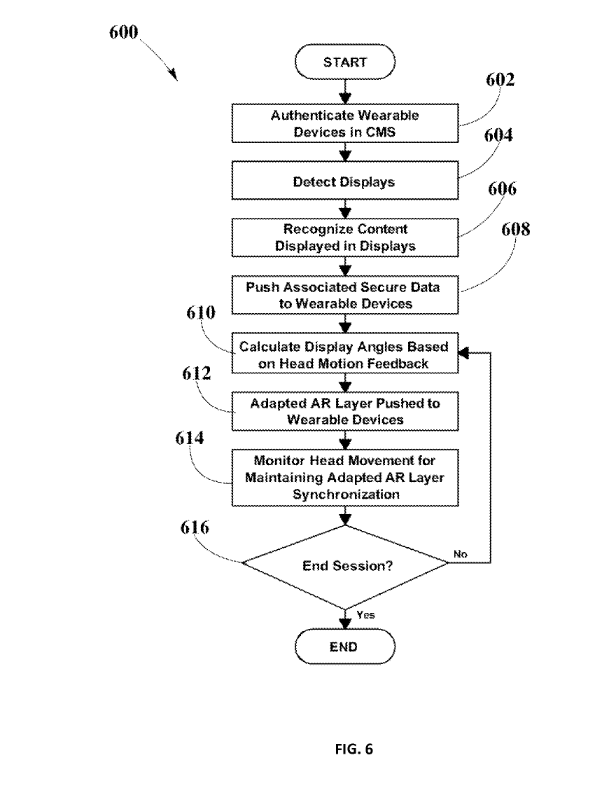

In some embodiments, users 518, 520, and 522 not only move their heads side-to-side (i.e., rolling), but in other head movement directions as well. In these embodiments, users 518, 520, and 522 move their bodies in different body movement directions as well. Further to these embodiments, if the users' head movements are slight and they are still looking at the same screen, the adapted AR layer will maintain synchronization with the screen. In these embodiments, if the users' head movements are substantial or the users look away from the screen for a predetermined period of time, the adapted AR layer is disabled and the users receive notifications of additional information in real time associated with the previously viewed background. In some embodiments, when the users return their viewing attention to any client computing device and maintain viewing the client computing device for a predetermined period of time, the content management system enables the adapted AR layer associated with the viewed client computing device and synchronizes the adapted AR layer with the screen. The aforedescribed embodiments are further detailed in in FIG. 6, below.

Method for Presenting Confidential Information to Authenticated Users of a Content Management System Using Augmented Reality.

In some embodiments, a plurality of processes that are part of the method for presenting confidential secure information to authenticated users of a content management system using augmented reality wearables are performed by one or more computing devices such as computing device 200 of FIG. 2. The methods are implemented using components of the exemplary operating environments of FIGS. 1 and 3-5. The steps of this exemplary method are embodied in a computer readable medium containing computer readable code such that the steps are implemented when the computer readable code is executed by a computing device. While the blocks in the disclosed processes are shown in a particular order, the actual order may differ. In some embodiments, some steps may be performed in parallel.

FIG. 6 is a flowchart of a method for presenting confidential information to authenticated users of a content management system using augmented reality. In some embodiments, method 600 operates within a content management system configured to present confidential information to authenticated users of wearable devices (e.g., glasses, watches, ear buds) using adapted AR layers on the screens of the wearable devices.

In one or more embodiments, method 600 begins when a user of a wearable device authenticates the wearable device with the content management system (step 602). In these embodiments, the authentication methods used are any form of authentication method known in the art. In one example, the user of the wearable device uses a two-step authentication process which includes user-identification data, such as user credentials (e.g., name, username, telephone number, password, and the like) plus biometric data of the user. The wearable device acquires the biometric data of the user and sends it with the user's credentials to the content management system. The content management system verifies the received credentials and biometric data against the credentials and biometric data previously stored within its internal database and grants access to the system when there is a positive match. The content management system then establishes a relationship with the wearable device. In some embodiments, the established relationship between the content management system and the wearable device includes the content management system taking control of the wearable device. Method 600 then advances to step 604.

At step 604, the content management system requests display identification data from the wearable device. In one embodiment, the request of the display identification data includes instructions instructing the camera of the wearable device to search for display identifiers (e.g., marks) that have been previously associated with displays and capture an image of the display identifier so the display can be detected by the content management system in conjunction with the camera of the wearable device. In one example, the marks are physical labels (e.g., stickers, tags) that can be located at the corners of each of the displays and identify the associated display (e.g., room location, location within the room, specific display within the system, and the like) to the content management system. Examples of display identifiers include two-dimensional barcodes, image tags, and the like. Method 600 then advances to step 606.

At step 606, the content management system receives the requested image of the display identifiers and processes the received display identifier image data to determine the display and associated content that the wearable device is viewing. In one embodiment, the image processing module compares the display identifier image data, including the content being displayed, to all content currently being pushed to all active displays so as to identify which display the user is viewing. In other embodiments, size and shape information of said display is also included within the display identifier image data. The content management system then identifies secure data or other user-specific data associated with the content currently being pushed to the display that the wearable device is viewing based on the user credentials supplied by the wearable device. Method 600 then advances to step 608.

At step 608, the content management system pushes the user-specific data (e.g., secure data that the user(s) is authorized to access) to the associated wearable device(s). In some embodiments, the content management system pulls the associated secure data from the internal database. In these embodiments, the content being displayed on displays is stored in a database on a local server. In other embodiments, the content management system receives the associated secure data in real time via an Internet cloud when the source is external to the system, such as, a global database. In some embodiments, the associated secure data includes a set of rules that allow the user to view custom information, such as, filling certain background areas of the display with different levels of confidential information, with product images according to a user's preferences, with live feed (e.g., video), or with content governed by parental control. Method 600 then advances to step 610.

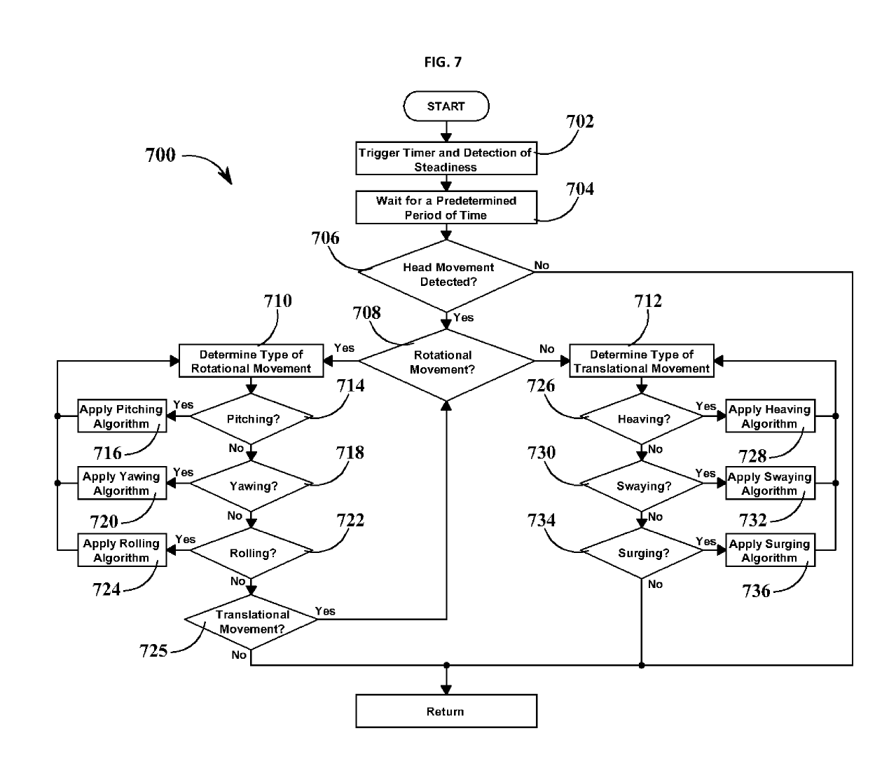

At step 610, the content management system calculates the head angle (rotational and translational movement) based on the motion feedback of the wearable device and/or runs an algorithm that can recognize the received image and detects the head angle of that image within the background. In these embodiments, the content management system uses the wearable device motion feedback and the head angles of the received image to map the secure data to the content that will be viewed on the wearable device. The content management system then produces an adapted AR layer based on the secure data mapping. This step is further described in FIG. 7. Method 600 then advances to step 612

At step 612, the content management system pushes the adapted AR layer to the associated display of the wearable device. In one or more embodiments, the display of the wearable device includes a screen area where the adapted AR layer is projected and a smaller screen area where live notifications related to the event are placed. Method 600 then advances to step 614.

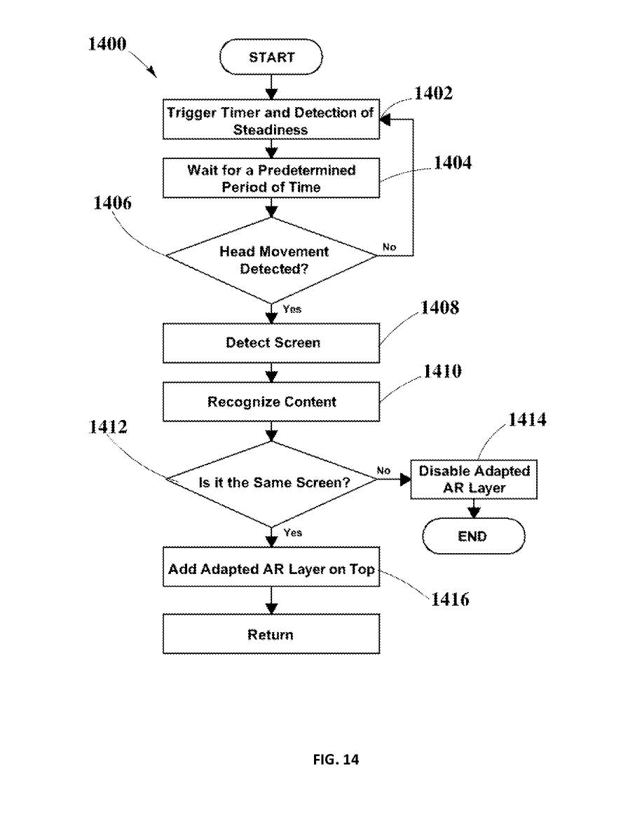

At step 614, the content management system monitors head movement of the wearable device to maintain adapted AR layer synchronization. In one or more embodiments, the content management system frequently checks to determine if the user is viewing the same display as well as how fast the user moves his head from side-to-side. This step is further described in FIG. 14. Method 600 then advances to decision step 616.

At decision step 616, the content management system determines if the user has ended the session. If the content management system determines the user has ended the session, method 600 ends. If the content management system determines the user has not ended the session, method 600 returns to step 610.

FIG. 7 is a flowchart of a method for calculating the rotational movement and translational movement of associated wearable devices with respect to the displays, according to an embodiment. In some embodiments, method 700 operates within a content management system that is configured to present confidential information to authenticated users of wearable devices (e.g., glasses, watches, ear buds, etc.) using adapted AR layers rendered onto the screens of the wearable devices and specific audible content to the audio portions of wearable devices. In one or more embodiments, method 700 functions as a subroutine running on a content management system. In these embodiments, for example, method 700 functions as a subroutine that is called by step 610 of method 600 described in FIG. 6, above.

In FIG. 7, method 700 begins when the content management system triggers a timer for detection of head and body steadiness in wearable devices (step 702). In these embodiments, the timer is set to count a predetermined period of time while constantly receiving data associated with user head and body movement. In one embodiment, data associated with the rotational and translational movement of the wearable devices includes data from a 3-axis gyroscope, a 3-axis accelerometer, and the like. In an example, the timer is set to 3 or more seconds. Method 700 then advances to step 704.

At step 704, the content management system waits for a predetermined period of time previously determined at step 702. Method 700 advances to a decision step 706.

At decision step 706, the content management system determines if there is user movement. In one embodiment, user movement is determined by analyzing the wearable device accelerometer and gyroscope data to determine user movement has exceeded a predetermined threshold value, such as, when a user rotates his head or moves from one position to another at a rate that indicates he is no longer viewing the associated display at the same angle. If there is no movement detected, method 700 returns to step 702. If there is movement detected, method 700 advances to decision step 708.

At decision step 708, the content management system determines the type of movement in which the users operating the wearable devices are engaged. In some embodiments, content management system determines if the movement includes a rotational component, a translational component, or both a rotational component and a translational component.

In some embodiments, the movement of the user is rotational as he or she moves the head in different directions, such as, for example, tilting forward and backward (pitching), turning left and right (yawing), and tilting side to side (rolling). Further, in these and other embodiments, the movement of the user is translational as he or she moves the body in different directions, such as, for example, moving up and down (heaving), moving left and right (swaying), and moving forward and backward (surging). If the content management system determines the movement includes a rotational component, method 700 advances to step 710. If the content management system determines the movement does not include a rotational component, method 700 advances to step 712.

At step 710, the content management system determines the type(s) of rotational movement the user is currently undertaking. In some embodiments, the movement of the user is rotational as he or she moves the head in different directions, such as, for example, tilting forward or backward around the x-axis (pitching), turning left or right around the y-axis (yawing), and tilting side to side around the z-axis (rolling). In these embodiments, the user can undertake movements that utilize one, some, or all of the aforedescribed rotational movements. Method 700 then advances to a decision step 714.

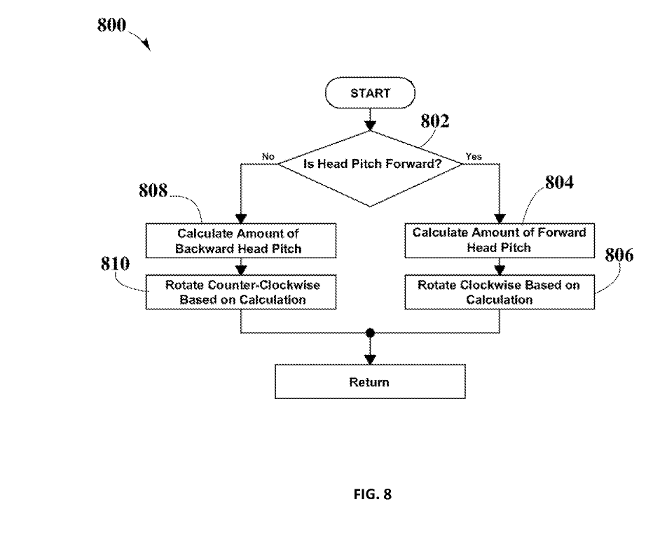

At decision step 714, the content management system determines if the rotational movement includes a pitching component. If there is a pitching component, then method 700 advances to step 716 where the content management system calls a pitching algorithm (further described in FIG. 8 below) to determine the value of the pitching component. Method 700 returns to step 710. If there is no pitching component as part of the rotational movement or the pitching component has already been solved for, then method 700 advances to a decision step 718.

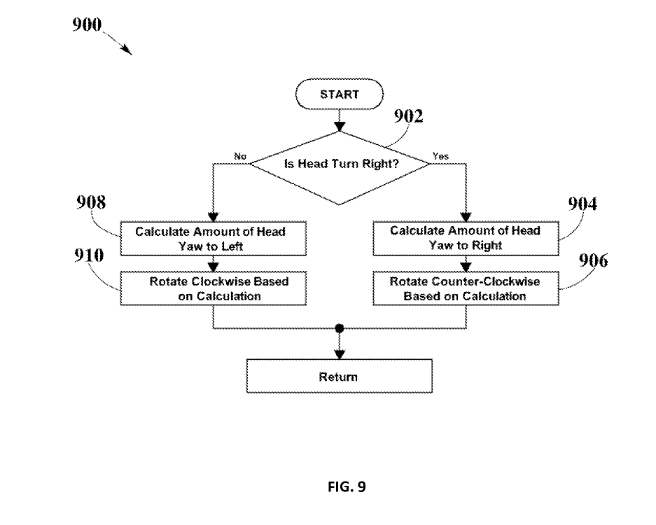

At decision step 718, the content management system determines if the rotational movement includes a yawing component. If there is a yawing component, then method 700 advances to step 720 where the content management system calls a yawing algorithm (further described in FIG. 9 below) to determine the value of the yawing component. Method 700 returns to step 710. If there is no yawing component as part of the rotational movement or the yawing component has already been solved for, then method 700 advances to a decision step 722.

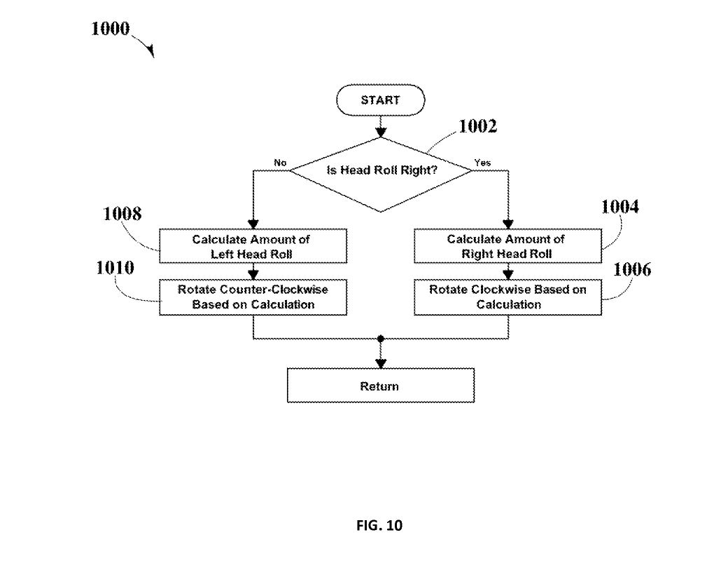

At decision step 722, the content management system determines if the rotational movement includes a rolling component. If there is a rolling component, then method 700 advances to step 724 where the content management system calls a rolling algorithm (further described in FIG. 10 below) to determine the value of the rolling component. Method 700 returns to step 710. If there is no rolling component as part of the rotational movement or the rolling component has already been solved for, then method 700 advances to decision step 725.

At decision step 725, method 700 determines if there is a translational component. If there is a translational component, method 700 returns to 708. If there is no translational component, method 700 returns to the program that called it, such as to step 610 of method 600 of FIG. 6, above.

At step 712, the content management system determines the type(s) of translational movement the user is currently undertaking. In some embodiments, the movement of the user is translational as he or she moves the body in different directions, such as, for example, moving the body up and down (heaving), moving the body left and right (swaying), and moving the body forward and backward (surging). In these embodiments, the user can undertake movements that utilize one, some, or all of the aforedescribed translational movements. Method 700 then advances to a decision step 726.

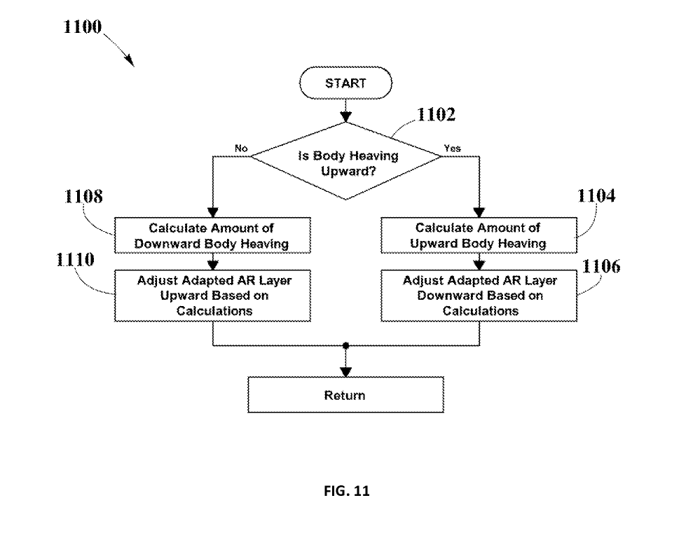

At decision step 726, the content management system determines if the translational movement includes a heaving component. If there is a heaving component, then method 700 advances to step 728 where the content management system calls a heaving algorithm (further described in FIG. 11 below) to determine the value of the heaving component. Method 700 returns to step 712. If there is no heaving component as part of the translational movement or the heaving component has already been solved for, then method 700 advances to a decision step 730.

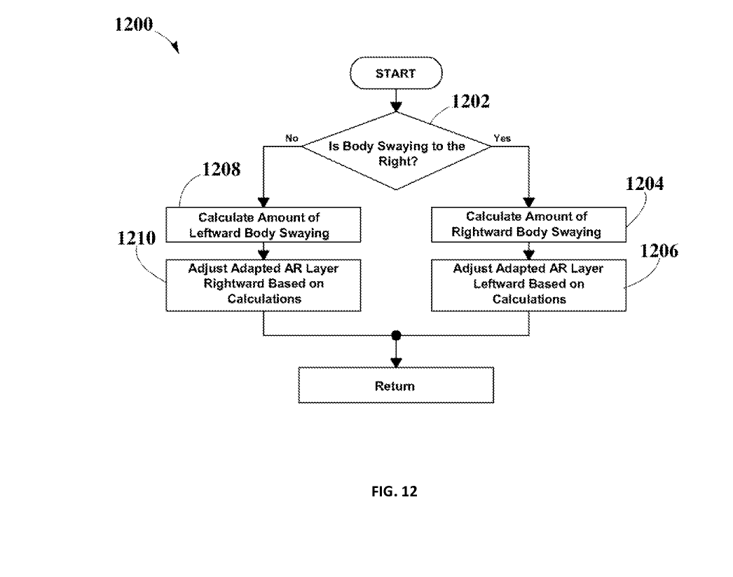

At decision step 730, the content management system determines if the translational movement includes a swaying component. If there is a swaying component, then method 700 advances to step 732 where the content management system calls a swaying algorithm (further described in FIG. 12 below) to determine the value of the swaying component. Method 700 returns to step 712. If there is no swaying component as part of the translational movement or the swaying component has already been solved for, then method 700 advances to a decision step 734.

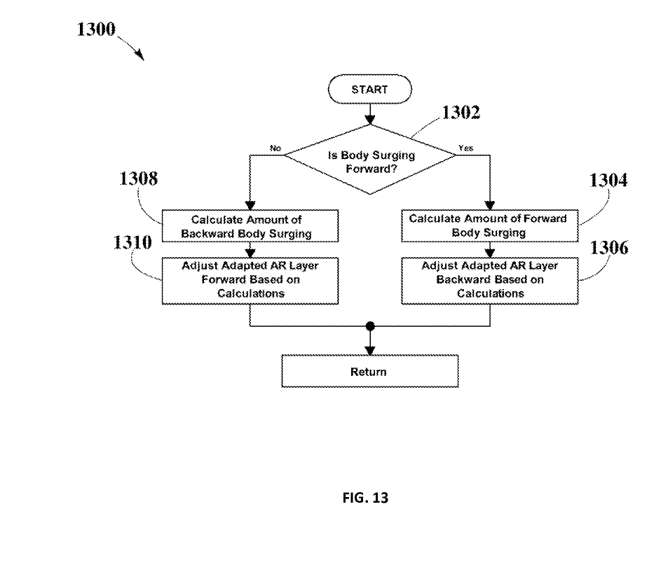

At decision step 734, the content management system determines if the translation movement includes a surging component. If there is a surging component, then method 700 advances to step 736 where the content management system calls a surging algorithm (further described in FIG. 13 below) to determine the value of the surging component. Method 700 returns to step 712. If there is no surging component as part of the translational movement or the surging component has already been solved for, then method 700 returns to the program that called it, such as to step 610 of method 600 of FIG. 6, above.

FIG. 8 is flowchart of a method for calculating the head pitch movement (tilting forward and backward around the x-axis) component based on the motion feedback of the wearable devices, according to an embodiment. In some embodiments, method 800 operates within a content management system configured to present confidential information to authenticated users of wearable devices (e.g., glasses, watches, ear buds, etc.) using adapted AR layers rendered onto the screens of the wearable devices. In an example, method 800 is a pitch subroutine called by step 716 of method 700 of FIG. 7, above.

In one or more embodiments, method 800 begins at decision step 802 where the content management system determines if there is user forward or backward head movement around the x-axis (pitching). In one embodiment, user forward or backward head movement is determined by analyzing the wearable device accelerometer and gyroscope data to determine user head forward or backward movement has exceeded a predetermined threshold value, such as, when a user rotates his head forward or backward at a rate that indicates he is no longer viewing the associated display at the same angle. If there is forward head movement detected, method 800 advances to step 804. If there is no forward head movement detected, method 800 advances to step 808.

At step 804, the content management system calculates the amount of forward head pitch. In one embodiment, the content management system uses received device accelerometer and gyroscope data to determine the angle (e.g., in degrees) that the user has tilted his head forward. Method 800 then advances to step 806.

At step 806, the content management system rotates the adapted AR layer clockwise about the x-axis based on the previous calculation performed in step 804. In one embodiment, the content management system uses the determined angle (e.g., in degrees) that the user has tilted his head forward so as to compensate for the forward head tilt in a clockwise rotation about the x-axis so the user can view the adapted AR layer aligned to the background of the screen in a substantially upright position. Method 800 returns to the program that called it, such as to step 716 of method 700 of FIG. 7, above.

At step 808, the content management system calculates the amount of user backward head pitch. In one embodiment, the content management system uses received device accelerometer and gyroscope data to determine the angle (e.g., in degrees) that the user has tilted his head backward. Method 800 then advances to step 810.

At step 810, the content management system rotates the adapted AR layer counter-clockwise about the x-axis based on the previous calculation performed in step 808. In one embodiment, the content management system uses the determined angle (e.g., in degrees) that the user has tilted his head backward so as to compensate for the backward head tilt in a counter-clockwise rotation about the x-axis so the user can view the adapted AR layer aligned to the background of the screen in a substantially upright position. Method 800 returns to the program that called it, such as to step 716 of method 700 of FIG. 7, above.

FIG. 9 is a flowchart of a method for calculating the head yaw movement (yawing left and right around the y-axis) component based on the motion feedback of the wearable devices, according to an embodiment. In some embodiments, method 900 operates within a content management system configured to present confidential information to authenticated users of wearable devices (e.g., glasses, watches, ear buds, etc.) using adapted AR layers rendered onto the screens of the wearable devices. In an example, method 900 is a yaw subroutine called by step 720 of method 700 of FIG. 7, above.

In one or more embodiments, method 900 begins at decision step 902 where the content management system determines if there is user left or right head movement around the y-axis (yawing). In one embodiment, user left or right head movement is determined by analyzing the wearable device accelerometer and gyroscope data to determine user head left or right movement has exceeded a predetermined threshold value, such as, when a user turns his head to the left or right at a rate that indicates he is no longer viewing the associated display at the same angle. If there is right head movement about the y-axis detected, method 900 advances to step 904. If there is no right head movement about the y-axis detected, method 900 advances to step 908.

At step 904, the content management system calculates the amount of head yaw to the right. In one embodiment, the content management system uses received device accelerometer and gyroscope data to determine the angle (e.g., in degrees) that the user has turned his head to the right. Method 900 then advances to step 906.

At step 906, the content management system rotates the adapted AR layer counter-clockwise about the y-axis based on the previous calculation performed in step 904. In one embodiment, the content management system uses the determined angle (e.g., in degrees) that the user has turned his head to the right so as to compensate for the right head turn in a counter-clockwise rotation about the y-axis so the user can view the adapted AR layer aligned to the background of the screen in a substantially upright position. Method 900 returns to the program that called it, such as to step 720 of method 700 of FIG. 7, above.

At step 908, the content management system calculates the amount of user head yaw to the left about the y-axis. In one embodiment, the content management system uses received device accelerometer and gyroscope data to determine the angle (e.g., in degrees) that the user has turned his head to the left. Method 900 then advances to step 910.

At step 910, the content management system rotates the adapted AR layer clockwise about the y-axis based on the previous calculation performed in step 908. In one embodiment, the content management system uses the determined angle (e.g., in degrees) that the user has turned his head to the left about the y-axis so as to compensate for the left head turn in a clockwise rotation about the y-axis so the user can view the adapted AR layer aligned to the background of the screen in a substantially upright position. Method 900 returns to the program that called it, such as to step 720 of method 700 of FIG. 7, above.

FIG. 10 is a flowchart of a method for calculating the head roll movement (side-to side) component based on the motion feedback of the wearable devices, according to an embodiment. In some embodiments, method 1000 operates within a content management system configured to present confidential information to authenticated users of wearable devices (e.g., glasses, watches, ear buds, etc.) using adapted AR layers rendered onto the screens of the wearable devices. In an example, method 1000 is a roll subroutine called by step 724 of method 700 of FIG. 7, above.

In one or more embodiments, method 1000 begins at decision step 1002 where the content management system determines if there is user side to side head movement around the z-axis (roll). In one embodiment, user side to side head movement around the z-axis is determined by analyzing the wearable device accelerometer and gyroscope data to determine user head movement has exceeded a predetermined threshold value, such as, when a user rotates his head side to side at a rate that indicates he is no longer viewing the associated display at the same lateral angle. If there is right head movement about the z-axis detected, method 1000 advances to step 1004. If there is no right head movement about the z-axis detected, method 1000 advances to step 1008.

At step 1004, the content management system calculates the amount of head roll to the right and about the z-axis. In one embodiment, the content management system uses received device accelerometer and gyroscope data to determine the angle (e.g., in degrees) that the user has rolled his head to the right. Method 1000 then advances to step 1006.

At step 1006, the content management system rotates the adapted AR layer clockwise about the z-axis based on the previous calculation performed in step 1004. In one embodiment, the content management system uses the determined angle (e.g., in degrees) that the user has rolled his head to the right about the z-axis so as to compensate for the right head roll in a clockwise rotation about the z-axis so the user can view the adapted AR layer aligned to the background of the screen in a substantially upright position. Method 1000 returns to the program that called it, such as to step 724 of method 700 of FIG. 7, above.

At step 1008, the content management system calculates the amount of user head roll to the left about the z-axis. In one embodiment, the content management system uses received device accelerometer and gyroscope data to determine the angle (e.g., in degrees) that the user has tilted his head to the left. Method 1000 then advances to step 1010.

At step 1010, the content management system rotates the adapted AR layer counter-clockwise about the z-axis based on the previous calculation performed in step 1008. In one embodiment, the content management system uses the determined angle (e.g., in degrees) that the user has rolled his head to the left about the z-axis so as to compensate for the left head roll in a counter-clockwise rotation about the z-axis so the user can view the adapted AR layer aligned to the background of the screen in a substantially upright position. Method 1000 returns to the program that called it, such as to step 724 of method 700 of FIG. 7, above.

FIG. 11 is a flowchart of a method for calculating the translational up or down movement (heaving) component based on the motion feedback of the wearable devices, according to an embodiment. In some embodiments, method 1100 operates within a content management system configured to present confidential information to authenticated users of wearable devices (e.g., glasses, watches, ear buds, etc.) using adapted AR layers rendered onto the screens of the wearable devices. In an example, method 1100 is a heaving subroutine called by step 728 of method 700 of FIG. 7, above.

In one or more embodiments, method 1100 begins at decision step 1102 where the content management system determines if there is user up or down translational movement (heaving). In one embodiment, user up or down translational movement is determined by analyzing the wearable device accelerometer and gyroscope data to determine user up or down translational movement has exceeded a predetermined threshold value, such as, when a user moves up or down at a rate that indicates he is no longer viewing the associated display at the same position and angle. If there is upward translational movement (heaving) detected, method 1100 advances to step 1104. If there is no upward translational movement detected, method 1100 advances to step 1108.

At step 1104, the content management system calculates the amount of upward body heaving. In one embodiment, the content management system uses received device accelerometer and gyroscope data to determine the distance that the body of the user has moved upward. Method 1100 then advances to step 1106.

At step 1106, the content management system adjusts the adapted AR layer in the opposite direction the body of the user has moved based on the previous calculation performed in step 1104. In one embodiment, the content management system uses the determined distance that the user has moved upward so as to compensate for the upward translational movement in the opposite direction the body of the user has moved so the user can view the adapted AR layer aligned to the background of the screen in a substantially upright position. Method 1100 returns to the program that called it, such as to step 728 of method 700 of FIG. 7, above.

At step 1108, the content management system calculates the amount of downward body heaving of the user. In one embodiment, the content management system uses received device accelerometer and gyroscope data to determine the distance that the body of the user has moved downward. Method 1100 then advances to step 1110.

At step 1110, the content management system adjusts the adapted AR layer in the opposite direction the body of the user has moved based on the previous calculation performed in step 1108. In one embodiment, the content management system uses the determined distance that the user has moved downward so as to compensate for the downward translational movement in the opposite direction the body of the user has moved so the user can view the adapted AR layer aligned to the background of the screen in a substantially upright position. Method 1100 returns to the program that called it, such as to step 728 of method 700 of FIG. 7, above.

FIG. 12 is a flowchart of a method for calculating the translational left and right movement (swaying) component based on the motion feedback of the wearable devices, according to an embodiment. In some embodiments, method 1200 operates within a content management system configured to present confidential information to authenticated users of wearable devices (e.g., glasses, watches, ear buds, etc.) using adapted AR layers rendered onto the screens of the wearable devices. In an example, method 1200 is a swaying subroutine called by step 732 of method 700 of FIG. 7, above.

In one or more embodiments, method 1200 begins at decision step 1202 where the content management system determines if there is user left or right translational movement (swaying). In one embodiment, user left or right translational movement is determined by analyzing the wearable device accelerometer and gyroscope data to determine user left or right translational movement has exceeded a predetermined threshold value, such as, when a user moves left or right at a rate that indicates he is no longer viewing the associated display at the same position and angle. If there is rightward translational movement (swaying) detected, method 1200 advances to step 1204. If there is no rightward translational movement detected, method 1200 advances to step 1208.

At step 1204, the content management system calculates the amount of rightward body swaying. In one embodiment, the content management system uses received device accelerometer and gyroscope data to determine the distance that the body of the user has moved rightward. Method 1200 then advances to step 1206.

At step 1206, the content management system adjusts the adapted AR layer in the opposite direction the body of the user has moved based on the previous calculation performed in step 1204. In one embodiment, the content management system uses the determined distance that the user has moved rightward so as to compensate for the rightward translational movement in the opposite direction the body of the user has moved so the user can view the adapted AR layer aligned to the background of the screen in a substantially upright position. Method 1200 returns to the program that called it, such as to step 732 of method 700 of FIG. 7, above.

At step 1208, the content management system calculates the amount of leftward body swaying of the user. In one embodiment, the content management system uses received device accelerometer and gyroscope data to determine the distance that the body of the user has moved leftward. Method 1200 then advances to step 1210.

At step 1210, the content management system adjusts the adapted AR layer in the opposite direction the body of the user has moved based on the previous calculation performed in step 1208. In one embodiment, the content management system uses the determined distance that the user has moved leftward so as to compensate for the leftward translational movement in the opposite direction the body of the user has moved so the user can view the adapted AR layer aligned to the background of the screen in a substantially upright position. Method 1200 returns to the program that called it, such as to step 732 of method 700 of FIG. 7, above.

FIG. 13 is a flowchart of a method for calculating the translational forward and backward movement (surging) component based on the motion feedback of the wearable devices, according to an embodiment. In some embodiments, method 1300 operates within a content management system configured to present confidential information to authenticated users of wearable devices (e.g., glasses, watches, ear buds, etc.) using adapted AR layers rendered onto the screens of the wearable devices. In an example, method 1300 is a surging subroutine called by step 736 of method 700 of FIG. 7, above

In one or more embodiments, method 1300 begins at decision step 1302 where the content management system determines if there is user forward or backward translational movement (surging). In one embodiment, user forward or backward translational movement is determined by analyzing the wearable device accelerometer and gyroscope data to determine user forward or backward movement has exceeded a predetermined threshold value, such as, when a user moves forward or backward at a rate that indicates he is no longer viewing the associated display at the same position and angle. If there is forward translational movement (surging) detected, method 1300 advances to step 1304. If there is backward translational movement detected, method 1300 advances to step 1308.

At step 1304, the content management system calculates the amount of forward body surging. In one embodiment, the content management system uses received device accelerometer and gyroscope data to determine the distance that the body of the user has moved forward. Method 1300 then advances to step 1306.

At step 1306, the content management system adjusts the adapted AR layer in the opposite direction the body of the user has moved based on the previous calculation performed in step 1304. In one embodiment, the content management system uses the determined distance that the user has moved forward so as to compensate for the forward translational movement in the opposite direction the body of the user has moved so the user can view the adapted AR layer aligned to the background of the screen in a substantially upright position. Method 1300 returns to the program that called it, such as to step 736 of method 700 of FIG. 7, above.

At step 1308, the content management system calculates the amount of backward body surging. In one embodiment, the content management system uses received device accelerometer and gyroscope data to determine the distance that the body of the user has moved backward. Method 1300 then advances to step 1310.

At step 1310, the content management system adjusts the adapted AR layer in the opposite direction the body of the user has moved based on the previous calculation performed in step 1308. In one embodiment, the content management system uses the determined distance that the user has moved backward so as to compensate for the backward translational movement in the opposite direction the body of the user has moved so the user can view the adapted AR layer aligned to the background of the screen in a substantially upright position. Method 1300 returns to the program that called it, such as to step 736 of method 700 of FIG. 7, above.

FIG. 14 is a flowchart illustrating a method for maintaining adapted AR layer synchronization by monitoring the head movement of the users of wearable devices. In some embodiments, method 1400 operates within a content management system configured to present confidential information to authenticated users of wearable devices (e.g., glasses, watches, ear buds, etc.) using adapted AR layers rendered onto the screens of the wearable devices. In an example, method 1400 is a subroutine called by step 614 of method 600 of FIG. 6, above.

In one or more embodiments, method 1400 begins when the content management system triggers a timer for detection of steadiness in wearable devices (step 1402). In these embodiments, the timer is set to count a predetermined period of time while constantly receiving data associated with user head movement as well as display identifier image data from the wearable devices. In one embodiment, data associated with user head movement includes wearable device accelerometer and the like. In an example, the timer is set to 3 or more seconds. Method 1400 then advances to step 1404.

At step 1404, the content management system waits for a predetermined period of time previously determined at step 1402. Method 1400 advances to a decision step 1406.

At decision step 1406, the content management system determines if there is user head movement. In one embodiment, user head movement is determined by analyzing the wearable device accelerometer data to determine user head movement has exceeded a predetermined threshold value, such as, when a user rotates his head sideways at a rate that indicates he is no longer viewing the associated display. In another embodiment, user head movement is determined by analyzing the display identifier image data to verify the user is no longer viewing the associated display. If there is no head movement detection, method 1400 returns to step 1402. If there is head movement detection, method 1400 advances to step 1408.

At step 1408, the content management system requests display identification data from the wearable device. In some embodiments, step 1408 is implemented in a substantially similar way as step 604 of FIG. 6. Method 1400 then advances to step 1410.

At step 1410, the content management system receives the requested image of the display identifiers and processes the received display identifier image data to determine the display and associated content the wearable device is viewing. In some embodiments, step 1410 is implemented in a substantially similar way as step 606 of FIG. 6. Method 1400 then advances to a decision step 1412.

At step 1412, the content management system determines if the screen that the user of the wearable device is currently looking at is the same screen the user was looking at in step 1402. If the screen the user of the wearable device is currently looking at is not the same as the screen the user was looking at in step 1402, method 1400 advances to step 1414. If the screen the user of the wearable device is currently looking at is the same as the screen the user was looking at in step 1402, method 1400 advances to step 1416.

At step 1414, the content management system disables the adapted AR layer mapped to the previous screen and the method ends.

At step 1416, the content management system maintains the adapted AR layer on top of the screen of the wearable device. Method 1400 returns to the program that called it, such as to step 614 of method 600 of FIG. 6, above.

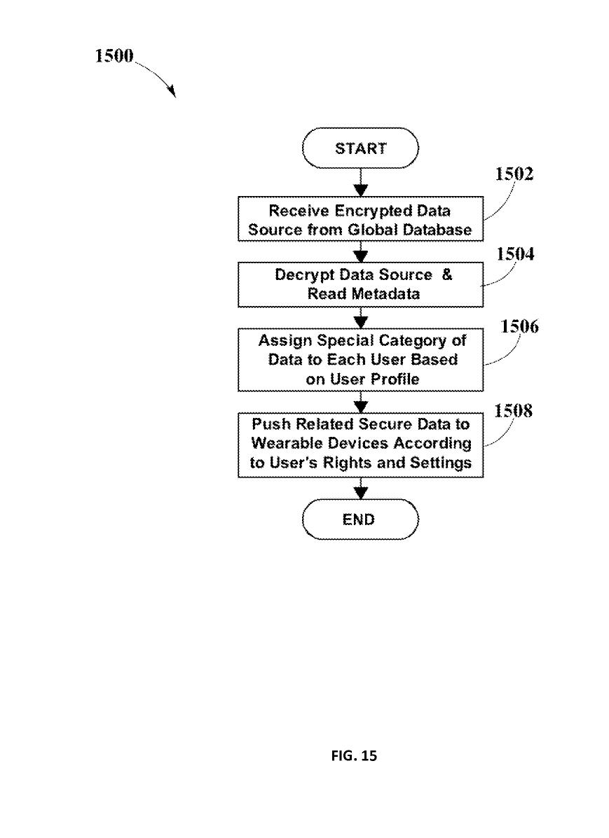

FIG. 15 is a flowchart of a method for processing encrypted metadata received from an outside source to be fed into the content management system. In some embodiments, method 900 operates within a content management system configured to present confidential information to authenticated users of the wearable devices (e.g., glasses, watches, ear buds) using adapted AR layers on the screens of the wearable devices.

In one or more embodiments, method 1500 begins when the content management system receives a data feed (e.g., live, pre-recorded, etc.) that includes encrypted data from an outside source such as a global database (step 1502). In these embodiments, the data processing module within the content management system receives the encrypted data and stores the received data at the internal database for further analysis. Method 1500 then advances to step 1504.

At step 1504, the data processing module, within the content management system, pulls the encrypted data from the internal database and runs programmatic rules or executes/runs different algorithms to decrypt the received encrypted data so as to access the metadata contained within the received encrypted data. In one embodiment, the metadata can be instructions or rules for the content management system to grant users rights to access all or specific portions of the received content/secure data. Method 1500 then advances to step 1506

At step 1506, the content management system assigns a special category of data to each user based on an associated user profile and the user rights contained within the metadata. In some embodiments, the user has the option (e.g., user preferences) to customize or otherwise decide what content to view or whether or not see the content/secure data being pushed to his wearable device from a specific or general source(s). Method 1500 then advances to step 1508.

At step 1508, the content management system, pushes the associated secure data to the wearable devices based on user rights and preferences. In some embodiments, the associated secure data includes the adapted AR layer and additional information such as live notifications related to the event being viewed by the user.

### EXAMPLE

This example refers to a system and method for presenting confidential information to authenticated users of a content management system through the aid of wearable devices and augmented reality (AR). In this example, the system includes all the components described in FIG. 1, and the method includes all the steps described in FIG. 6. Further in this example, the system is deployed in a conference room as described in FIG. 4. The conference room is equipped with two displays connected to a PC as client computing devices, three AR glasses as wearable devices, and three smartphones as wireless enabled devices. The displays and associated PC are connected to a content management system via a communication network. The glasses are connected and authenticated with the content management system through the smartphones via a communication network. In the conference room, there are also three users that have previously been registered with the content management system under different user levels. The first user has the highest user level which allows him full access to the confidential information. The second user has a mid-level user level which allows him access to see portions of the confidential information. The third user has a low user level which allows him to see less confidential information than the first or second user. The three users are wearing glasses that include, but are not limited to, a camera, a display, and a plurality of sensors such as, for example, 3-axis gyroscope, 3-axis accelerometer, ambient light sensing, proximity sensors, and the like. The displays hang on a wall next to each other and receive content, such as, video and/or images from the content management system via the communication network. The received content (e.g., camera data, sensor data, etc.) includes a common background such as a video or still images that can be seen by any of the users in the conference room when not wearing the glasses. The received content may be fed from internal or external sources. The users, when wearing the glasses, can see additional information that the content management system pushes to each of the wearable devices. The additional information viewed by each user can be different based on the user's associated user level. The additional information is presented as an adapted augmented reality layer that is rendered on the wearable device display on top of the image/video being displayed by the displays. This additional information is configured for each of the users according to the user's rights and settings. The content management system uses different algorithms to map and synchronize the display angles of the displays with the wearable devices so that the additional information always looks upright and aligned to the common background of the displays.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

Any reference to claim elements in the singular, for example, using the articles “a,” “an” or “the,” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A method, implemented by a content management system including one or more processors, the method comprising:
receiving, at the content management system and from a client device, a request to authenticate the client device;
authenticating, by the content management system, the client device;
receiving position information associated with the client device;
determining that a user of the client device has access to user-specific content based on the authenticating; and
providing, by the content management system and to the client device, the user-specific content that corresponds to the position information and the user.

2. The method of claim 1, the method further comprising:
determining, by the content management system, preferences associated with the user;
wherein providing the user-specific content to the client device is further based on the preferences.

3. The method of claim 1, wherein the position information comprises at least one of a group consisting of: a location of the client device, a view of the client device, or an angle of view of the client device.

4. The method of claim 1, the method further comprising:
prior to providing the user-specific content to the client device, rendering an adapted augmented reality (“AR”) layer for display on the client device based on the position information, wherein the adapted AR layer comprises the user-specific content; and
wherein providing the user-specific content comprises:
providing the adapted AR layer to the client device.

5. The method of claim 4, wherein the position information comprises camera data captured by a camera of the client device, and wherein the camera data comprises content, associated with the content management system, displayed by a second client device.

6. The method of claim 5, wherein the content displayed by the second client device is non-private content associated with the content management system.

7. The method of claim 5, wherein rendering the adapted AR layer comprises:
positioning the user-specific content on top of the content displayed by the second client device.

8. The method of claim of claim 4, further comprising:
receiving subsequent position information associated with the client device; and
rendering a second adapted AR layer for display on the client device based on the subsequent position information, wherein:
the second adapted AR layer comprises the user-specific content, and
providing the user-specific content further comprises:
providing the second adapted AR layer to the client device.

9. The method of claim 1, wherein the user-specific content comprises at least one of a group consisting of: video content, textual content, image content, or audio content.

10. The method of claim 1, further comprising:
receiving, at the content management system and from a second client device, a request to authenticate the second client device;
authenticating, by the content management system, the second client device;
receiving position information associated with the second client device;
determining that a user of the second client device has access to second user-specific content based on the authenticating the second client device, wherein the second user-specific content is different from the user-specific content and comprises at least a part of the user-specific content; and
providing, by the content management system and to the second client device, the second user-specific content that corresponds to the position information associated with the second client device and the user of the second client device.

11. A method, implemented by a client device including one or more processors, the method comprising:
transmitting, by the client device and to a content management system, a request to authenticate the client device, wherein the request includes user-identification data from a user of the client device;
determining, by the client device, position information for the client device;
receiving, by the client device and from the content management system, user-specific content, wherein the content management system determined that the user of the client device has access to the user-specific content based on authenticating the client device using the user-identification data;
rendering, by the client device, an adapted augmented reality (“AR”) layer based on the position information, wherein the adapted AR layer comprises the user-specific content; and
displaying, by the client device, the adapted AR layer on a display of the client device.

12. The method of claim 11, the method further comprising:
determining, by the client device, preferences associated with the user;
wherein rendering the adapted AR layer is further based on the preferences.

13. The method of claim 11, wherein the position information comprises at least one of a group consisting of: a location of the client device, a view of the client device, or an angle of view of the client device.

14. The method of claim 11, the method further comprising capturing camera data using a camera of the client device wherein the position information comprises the camera data, and wherein the camera data comprises content, associated with the content management system, displayed by a second client device.

15. The method of claim 14, wherein the content displayed by the second client device is non-private content associated with the content management system.

16. The method of claim 14, wherein rendering the adapted AR layer comprises:
positioning the user-specific content on top of the content displayed by the second client device.

17. The method of claim of claim 11, the method further comprising:
determining subsequent position information associated with the client device; and
rendering a second adapted AR layer for display on the client device based on the subsequent position information, wherein the second adapted AR layer comprises the user-specific content; and
displaying the second adapted AR layer.

18. The method of claim 11, wherein the user-specific content comprises at least one of a group consisting of: video content, textual content, image content, or audio content.

19. A system comprising:
a processor; and
a memory, operably connected to the processor, storing instructions which, when executed on the processor, cause the system to:
receive, at a content management system and from a client device, a request to authenticate the client device;
authenticate, by the content management system, the client device;
receive position information associated with the client device;
determine that a user of the client device has access to user-specific content based on the authenticating; and
provide, by the content management system and to the client device, the user-specific content that corresponds to the position information and the user.

20. A non-transitory computer readable storage medium including instructions which when executed cause a processor to perform a method comprising:
receiving, at a content management system and from a client device, a request to authenticate the client device;
authenticating, by the content management system, the client device;
receiving position information associated with the client device;
determining that a user of the client device has access to user-specific content based on the authenticating; and
providing, by the content management system and to the client device, the user-specific content that corresponds to the position information and the user.
